(19) United States
(12) Patent Application Publication
(10) Pub. No.: US 2017/0136615 A1
(43) Pub. Date: May 18, 2017

(54) Wrench System

(71) Applicant: Ken Storey, Mississauga (CA)

(72) Inventor: Ken Storey, Mississauga (CA)

(21) Appl. No.: 14/940,458

(22) Filed: Nov. 13, 2015

(51) Int. Cl. B25G 1/00; B25B 13/46; B25G 1/04

(52) U.S. Cl. CPC B25G 1/005; B25G 1/043; B25B 13/461

(57) ABSTRACT

A wrench system includes a socket wrench that has a head and a handle. The head may have a socket removably coupled thereto thereby facilitating the socket wrench to manipulate a fastener. The handle may be gripped thereby facilitating the fastener to be selectively tightened or loosened. An extension is removably coupled to the head such that the extension may be gripped. Thus, an increased rotational torque may be applied to the socket wrench compared to gripping only the handle.

### BACKGROUND OF THE DISCLOSURE

### Field of the Disclosure

The disclosure relates to wrench devices and more particularly pertains to a new wrench device for loosening a fastener.

### SUMMARY OF THE DISCLOSURE

An embodiment of the disclosure meets the needs presented above by generally comprising a socket wrench that has a head and a handle. The head may have a socket removably coupled thereto thereby facilitating the socket wrench to manipulate a fastener. The handle may be gripped thereby facilitating the fastener to be selectively tightened or loosened. An extension is removably coupled to the head such that the extension may be gripped. Thus, an increased rotational torque may be applied to the socket wrench compared to gripping only the handle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a wrench system according to an embodiment of the disclosure.

FIG. 2 is a top view of an embodiment of the disclosure.

FIG. 3 is a cross sectional view taken along line 3-3 of FIG. 2 of an embodiment of the disclosure.

FIG. 4 is a right side view of an embodiment of the disclosure.

FIG. 5 is a perspective in-use view of an embodiment of the disclosure.

### DESCRIPTION OF THE PREFERRED EMBODIMENT

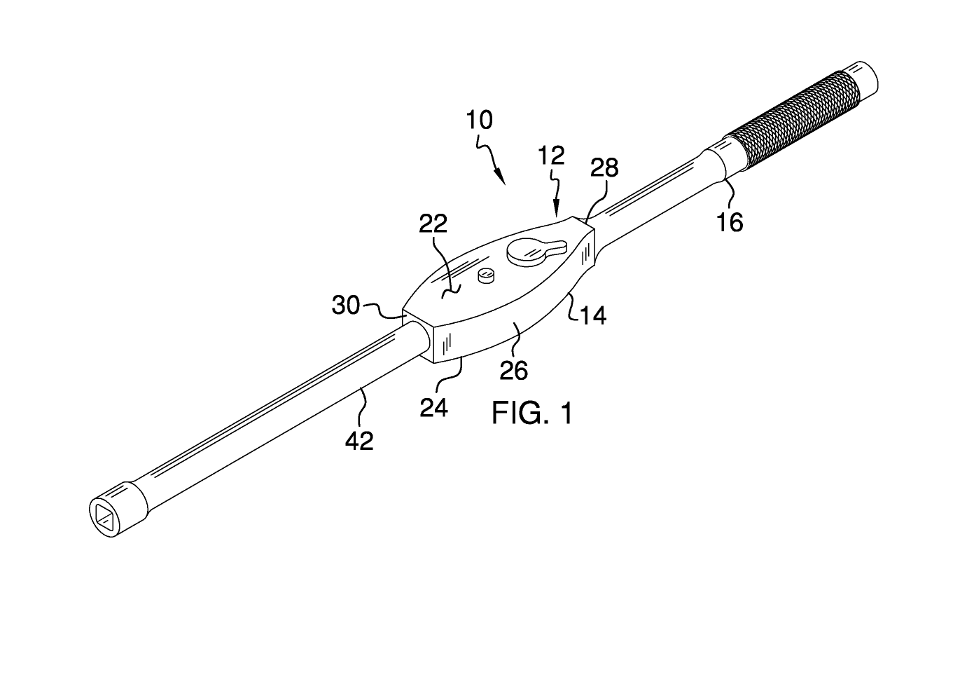

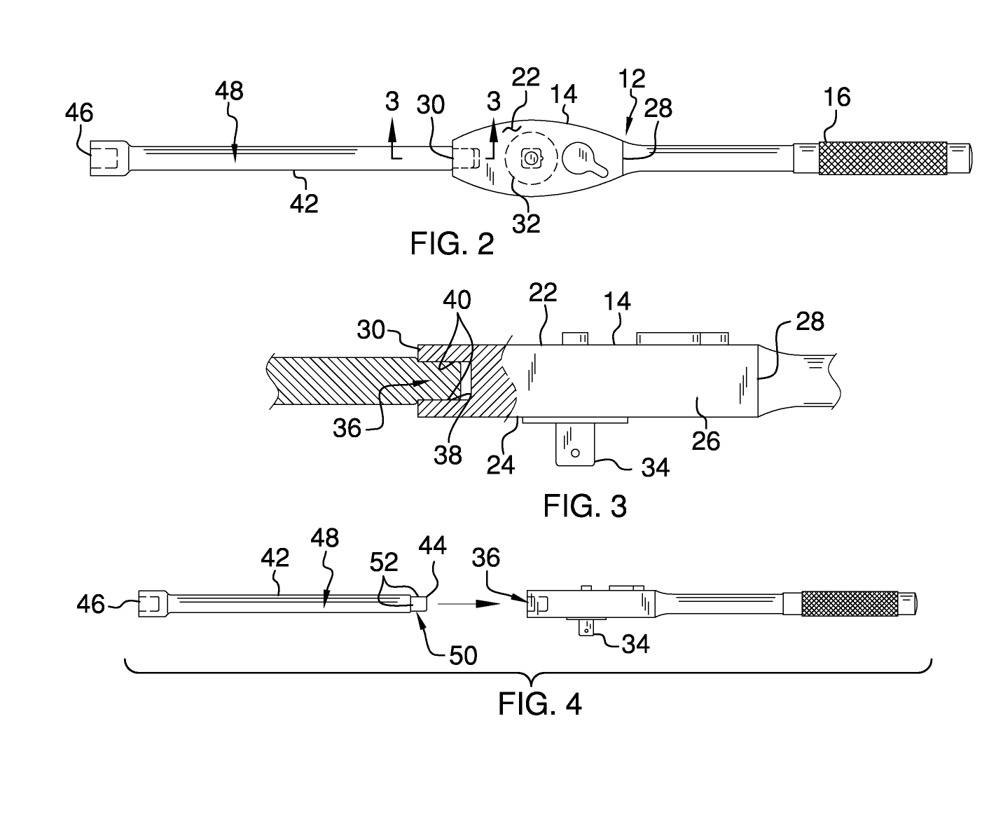

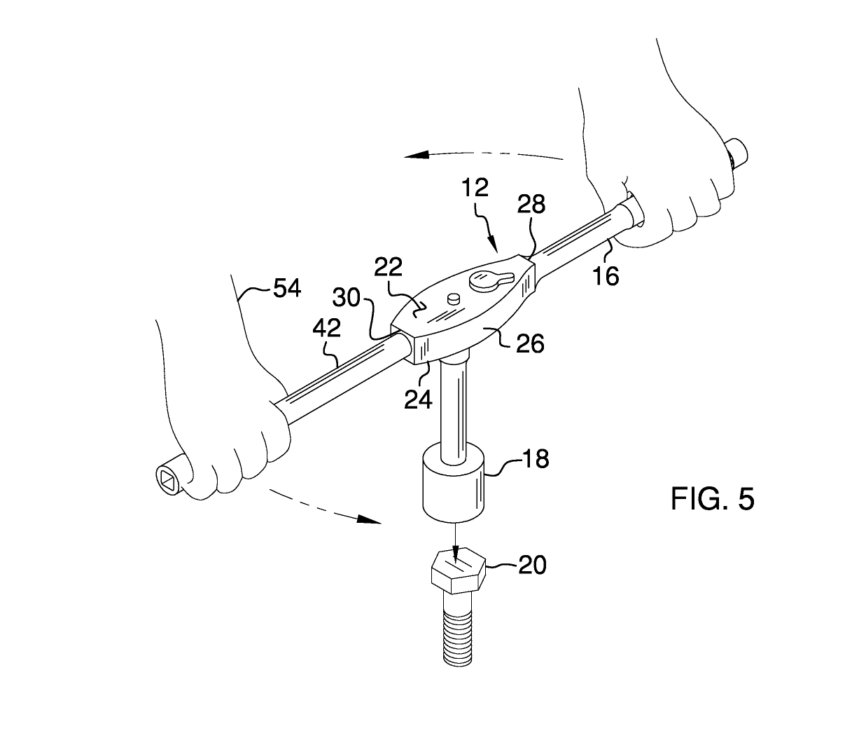

With reference now to the drawings, and in particular to FIGS. 1 through 5 thereof, a new wrench device embodying the principles and concepts of an embodiment of the disclosure and generally designated by the reference numeral 10 will be described.

As best illustrated in FIGS. 1 through 5, the wrench system 10 generally comprises a socket wrench 12 that has a head 14 and a handle 16. The head 14 may have a socket 18 removably coupled thereto thereby facilitating the socket wrench 12 to manipulate a fastener 20. The socket 18 may be a socket utilized in the convention of tightening and loosening nuts and bolts. The fastener 20 may comprise a nut and a bolt or the like. The handle 16 may be gripped thereby facilitating the fastener 20 to be selectively tightened or loosened.

The head 14 has a first surface 22, a second surface 24 and a peripheral edge 26 extending between the first surface 22 and the second surface 24. The peripheral edge 26 has a front side 28 and a back side 30 and the head 14 is elongated between the front side 28 and the back side 30. The handle 16 is coupled to and extends laterally away from the front side 28. The head 14 includes a ratcheting mechanism 32 and the ratcheting mechanism 32 may comprise any ratcheting mechanism commonly utilized in the convention of socket wrenches 12.

A tang 34 is rotatably coupled to the second surface 24. The tang 34 extends downwardly from the second surface 24. The tang 34 is in mechanical communication with the ratcheting mechanism 32. Thus, the tang 34 is selectively locked to rotate in a clockwise direction or a counterclockwise direction. The tang 34 may have the socket 18 removably coupled thereto. The back side 30 has a well 36 extending inwardly therein and the well 36 has a bounding surface 38. The bounding surface 38 has a plurality of intersecting sides 40 such that the well 36 has a rectangular shape.

An extension 42 is provided and the extension 42 may be removably coupled to the head 14. Thus, the extension 42 may be gripped thereby facilitating a rotational torque to be applied to the socket wrench 12. The extension 42 has a first end 44, a second end 46 and an outer surface 48 extending between the first end 44 and the second end 46. The extension 42 may comprise any socket wrench extension or the like.

The outer surface 48 has a coupling section 50 that is positioned adjacent to the first end 44. The coupling section 50 has a plurality of intersecting sides 52. Thus, the coupling section 50 has a square cross section taken perpendicular to a line extending through the first end 44 and the second end 46. The coupling section 50 is removably inserted into the well 36 such that the extension 42 extends laterally away from the back side 30. Thus, the extension 42 is aligned with the handle 16. Each of the handle 16 and the extension 42 may be gripped thereby facilitating a user 54 to apply an increased rotational torque to the fastener 20 compared to the user 54 gripping only the handle 16.

In use, the extension 42 is coupled to the head 14 if the fastener 20 is too tight to loosen with only the handle 16. The ratcheting mechanism 32 is manipulated to allow the tang 34 to rotate in the clockwise direction thereby facilitating the fastener 20 to be rotated in a counterclockwise direction. The socket wrench 12 is manipulated to facilitate the socket 18 to engage the fastener 20. The handle 16 and the extension 42 are gripped and the socket wrench 12 is rotated counterclockwise along an axis extending through the first surface 22 and the second surface 24. Thus, the fastener 20 is loosened.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wrench system comprising:
a socket wrench having a head and a handle, said head being configured to have a socket removably coupled thereto thereby facilitating said socket wrench to manipulate a fastener, said handle being configured to be gripped thereby facilitating the fastener to be selectively tightened or loosened; and
an extension being removably coupled to said head such that said extension is configured to be gripped thereby facilitating an increased rotational torque to be applied to said socket wrench compared to gripping only said handle.

2. The system according to claim 1, wherein said head has a first surface, a second surface and a peripheral edge extending between said first surface and said second surface, said peripheral edge having a front side and a back side, said head being elongated between said front side and said back side, said handle being coupled to and extending laterally away from said front side.

3. The system according to claim 2, wherein said back side has a well extending inwardly therein, said well having a bounding surface.

4. The system according to claim 3, wherein said bounding surface has a plurality of intersecting side such that said well has a rectangular shape.

5. The system according to claim 2, wherein said second surface has a tang being rotatably coupled thereto and extending downwardly therefrom, said tang being selectively locked to rotate in a clockwise direction or a counterclockwise direction, said tang being configured to have the socket removably coupled thereto.

6. The system according to claim 1, wherein said extension has a first end, a second end and a outer surface extending between said first end and said second end, said outer surface having a coupling section being positioned adjacent to said first end.

7. The system according to claim 6, wherein said coupling section has a plurality of intersecting sides such that said coupling section has a square cross section taken perpendicular to a line extending through said first end and said second end.

8. The system according to claim 1, wherein:
said head has a well; and
said coupling section being removably inserted into said well such that said extension extends laterally away from said back side such that said extension is aligned with said handle, each of said handle and said extension being configured to be gripped thereby facilitating a user to apply an increased rotational torque to the fastener compared the user gripping only said handle.

9. A wrench system comprising:
a socket wrench having a head and a handle, said head being configured to have a socket removably coupled thereto thereby facilitating said socket wrench to manipulate a fastener, said handle being configured to be gripped thereby facilitating the fastener to be selectively tightened or loosened, said head having a first surface, a second surface and a peripheral edge extending between said first surface and said second surface, said peripheral edge having a front side and a back side, said head being elongated between said front side and said back side, said handle being coupled to and extending laterally away from said front side, said back side having a well extending inwardly therein, said well having a bounding surface, said bounding surface having a plurality of intersecting side such that said well has a rectangular shape, said second surface having a tang being rotatably coupled thereto and extending downwardly therefrom, said tang being selectively locked to rotate in a clockwise direction or a counterclockwise direction, said tang being configured to have the socket removably coupled thereto; and
an extension being removably coupled to said head such that said extension is configured to be gripped thereby facilitating a rotational torque to be applied to said socket wrench, said extension having a first end, a second end and a outer surface extending between said first end and said second end, said outer surface having a coupling section being positioned adjacent to said first end, said coupling section having a plurality of intersecting sides such that said coupling section has a square cross section taken perpendicular to a line extending through said first end and said second end, said coupling section being removably inserted into said well such that said extension extends laterally away from said back side such that said extension is aligned with said handle, each of said handle and said extension being configured to be gripped thereby facilitating a user to apply an increased rotational torque to the fastener compared the user gripping only said handle.
